(19) United States
(12) Patent Application Publication
(10) Pub. No.: US 2026/0112512 A1
(43) Pub. Date: Apr. 23, 2026

(54) SYSTEM AND METHOD FOR DETECTING LEAKS IN A NUCLEAR FUEL POOL ASSEMBLY

(71) Applicant: Westinghouse Electric Company LLC, Cranberry Township, PA (US)

(72) Inventors: James T. Polidora, North Huntingdon, PA (US); Cory D. Hildebrand, Mount Pleasant, PA (US)

(73) Assignee: Westinghouse Electric Company LLC, Cranberry Township, PA (US)

(21) Appl. No.: 18/920,182

(22) Filed: Oct. 18, 2024

(51) Int. Cl. G21C 17/00; G21C 17/017

(52) U.S. Cl. CPC G21C 17/002; G21C 17/017

(57) ABSTRACT

A system and method for detecting leaks in nuclear fuel pool assemblies utilize ultrasonic technology to provide safety and integrity. The system includes an inner tube with cobalt slugs, surrounded by an outer tube, both submerged in water. Magnets align the slugs, while ultrasonic transducers transmit and receive waves to detect water presence. A pulse generator excites the transducers, and a control circuit analyzes signal changes to identify leaks. The system operates at frequencies between 50 kHz and 500 kHz, with pulse amplitudes from 50 to 500 volts. A spectrum analyzer enhances detection accuracy by evaluating power distribution across frequencies. The method involves aligning slugs, transmitting waves, and analyzing amplitude changes to confirm water ingress, optimizing detection through strategic transducer positioning and signal analysis.

### TECHNICAL FIELD

The present disclosure relates generally to a system and method for detecting leaks in nuclear fuel pool assemblies. More particularly, this disclosure is directed to a system and method utilizing ultrasonic technology and magnetic alignment to detect water ingress into sealed cobalt-containing tubes.

### BACKGROUND

In nuclear fuel pools, maintaining the integrity of cobalt-containing assemblies is essential. Leaks in the inner tubes containing cobalt slugs can lead to increased radiation levels, compromising reactor safety. Current leak detection methods are inefficient, often requiring disassembly of the assemblies. There is a need for a non-invasive, accurate, and efficient system to detect water ingress without disassembly, to minimize delays during outages. Monitoring and maintaining the integrity of these assemblies is important to provide safe and efficient operation within nuclear facilities. Traditional methods of leak detection in such environments can be unreliable or insufficient, especially when dealing with the complex configurations found in fuel pools.

To irradiate targets and produce radioactive isotopes of Cobalt in a nuclear reactor, Cobalt Burnable Absorber (COBA) insert assemblies are placed into nuclear fuel assemblies and loaded into the reactor core as components for irradiation over multiple fuel cycles. Once the COBA insert assemblies are removed from the core, the activated capsules containing the irradiated targets are extracted from the COBA rodlets.

The presence of water in a sealed capsule indicates a leaking COBA insert assembly. If increased Cobalt radioactivity is detected through water sampling, a utility would avoid reinserting a leaking COBA assembly into the reactor core. Without an effective leak detection method, all COBA assembly inserts might be excluded from the next cycle, causing significant challenges in core fuel loading.

### SUMMARY

In a first embodiment, the present disclosure describes a system for detecting leaks in a nuclear fuel pool assembly. The system includes an inner tube containing a plurality of cobalt slugs and an outer tube surrounding the inner tube. Both the inner tube and the outer tube are submerged in water. One or more magnets align the cobalt slugs within the inner tube. One or more ultrasonic transducers are positioned in proximity to the inner tube and the outer tube, offset from a centerline of the outer tube, for transmitting and receiving ultrasonic signals. A generator circuit excites at least one of the one or more ultrasonic transducers using an electrical excitation signal. A control circuit analyzes changes in signal amplitude to detect a presence of water in the inner tube.

In one aspect of the first embodiment, the one or more ultrasonic transducers operate at a frequency in a range 50 kilohertz to 500 kilohertz and are positioned to optimize leak detection.

In another aspect of the first embodiment, which may be combined with one or more previously recited aspects of the first embodiment, the generator circuit excites at least one of the one or more ultrasonic transducers using a pulse with an amplitude magnitude in a range of 50 volts to 500 volts with a pulse width in a range of 50 nanoseconds to 10 microseconds and a repetition frequency in a range of 10 hertz to 1,000 hertz.

In another aspect of the first embodiment, which may be combined with one or more previously recited aspects of the first embodiment, a gating circuit analyzes individual signal peaks and determines whether the inner tube is dry or wet.

In another aspect of the first embodiment, which may be combined with one or more previously recited aspects of the first embodiment, the control circuit analyzes resonance patterns of received electrical signals to detect changes caused by water in the inner tube.

In another aspect of the first embodiment, which may be combined with one or more previously recited aspects of the first embodiment, the control circuit measures a time delay between a received electrical signal and the electrical excitation signal to calculate signal propagation and amplitude.

In another aspect of the first embodiment, which may be combined with one or more previously recited aspects of the first embodiment, a spectrum analyzer circuit analyzes power distribution over a frequency range to improve detection accuracy.

In a second embodiment, the present disclosure describes a method for detecting leaks in a nuclear fuel pool assembly. At least one magnet aligns a cobalt slug within an inner tube. At least one transmitting ultrasonic transducer is excited with an electrical excitation signal. The at least one ultrasonic transducer transmits an ultrasonic signal through the inner tube and an outer tube while they are submerged in water. A reflected ultrasonic signal is received by at least one receiving ultrasonic transducer. The reflected ultrasonic signal is converted to a received electrical signal. Changes in an amplitude of the received electrical signal are analyzed by a control circuit or spectrum analyzer circuit to detect a presence of water within the inner tube, indicating a leak.

In one aspect of the second embodiment, the at least one transmit or receiving ultrasonic transducer is positioned offset from a centerline of the inner tube and the outer tube to optimize leak detection.

In another aspect of the second embodiment, which may be combined with one or more previously recited aspects of the second embodiment, the ultrasonic signals are transmitted by exciting a piezoelectric crystal in the at least one transmitting ultrasonic transducer using an electrical pulse with an amplitude magnitude in a range of 50 volts to 500 volts and an electrical pulse width in a range of 50 nanoseconds to 10 microseconds.

In another aspect of the second embodiment, which may be combined with one or more previously recited aspects of the second embodiment, individual peaks in the received electrical signals are gated and analyzed to determine whether the inner tube is dry or wet.

In another aspect of the second embodiment, which may be combined with one or more previously recited aspects of the second embodiment, a time delay between the electrical excitation signal and the received electrical signal is calculated to determine a velocity of water within the outer tube and the information is used to confirm the presence of a leak in the inner tube.

In another aspect of the second embodiment, which may be combined with one or more previously recited aspects of the second embodiment, individual cobalt slugs or rodlets within the assembly are tested by selectively analyzing the received electrical signal corresponding to each slug or rodlet and determining whether a specific slug or rodlet is associated with a leak.

In another aspect of the second embodiment, which may be combined with one or more previously recited aspects of the second embodiment, a frequency of the transmitted ultrasonic signals is adjusted in a range of 50 kilohertz to 500 kilohertz to enhance detection accuracy.

In another aspect of the second embodiment, which may be combined with one or more previously recited aspects of the second embodiment, electrical power distribution is analyzed over a range of frequencies using the spectrum analyzer circuit to improve detection accuracy of the leak and the analyzed electrical power distribution data is compared with predefined thresholds to determine whether water ingress has occurred.

In a third embodiment, the present disclosure describes a method for detecting water ingress in a sealed cobalt-containing capsule submerged in a nuclear fuel pool. At least one ultrasonic transducer is positioned near the capsule. An ultrasonic signal is transmitted through the capsule. Changes in amplitude and resonance patterns between a transmitted ultrasonic signal and a reflected ultrasonic signal are analyzed to detect presence of water within the capsule by analyzing. The reflected ultrasonic signal is compared to predetermined baseline measurements for non-leaking capsules to confirm water ingress.

In one aspect of the third embodiment, adjusting a position of at least one cobalt slug located within the capsule with magnets to provide uniform ultrasonic transmission and reception.

In another aspect of the third embodiment, which may be combined with one or more previously recited aspects of the third embodiment, consistent resonance patterns and changes in ultrasonic signal amplitude are detected to determine the presence of water within the capsule.

In another aspect of the third embodiment, which may be combined with one or more previously recited aspects of the third embodiment, offset positioning of the at least one ultrasonic transducer is adjusted relative to a centerline of the capsule to optimize detection sensitivity.

In another aspect of the third embodiment, which may be combined with one or more previously recited aspects of the third embodiment, the sealed cobalt-containing capsule is calibrated by transmitting test signals through non-leaking capsules to establish baseline resonance and amplitude patterns for comparison.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The apparatuses, systems, and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 depicts a Cobalt Burnable Absorber (COBA) assembly, according to one aspect of this disclosure.

FIG. 2 illustrates a leak detection system positioned over a COBA rodlet, according to one aspect of this disclosure.

FIG. 3 shows a sectional view of a leak detection system with a dry inner tube, according to one aspect of this disclosure.

FIG. 4 illustrates the system with a wet inner tube, indicating a leak, according to one aspect of this disclosure.

FIG. 5 illustrates a system for detecting leaks in a nuclear fuel pool assembly, according to one aspect of this disclosure.

FIG. 6 shows a resonance pattern of a received signal for a dry inner tube, according to one aspect of this disclosure.

FIG. 7 shows a resonant pattern of a received signal for a wet inner tube, according to one aspect of this disclosure.

FIG. 8 is a method for detecting leaks in a nuclear fuel pool assembly, according to one aspect of the present disclosure.

FIG. 9 is a method for detecting water ingress in a sealed cobalt-containing capsule submerged in a nuclear fuel pool, according to one aspect of the present disclosure.

### DESCRIPTION

The present disclosure describes a system and method for detecting leaks in a nuclear fuel pool assembly. The system includes an inner tube containing a series of cobalt slugs and an outer tube filled with water, both of which are submerged in a nuclear fuel pool. The system utilizes one or more magnets to align the cobalt slugs within the inner tube, ensuring consistency for ultrasonic signal detection and uniformity for leak detection. Ultrasonic transducers are offset from a centerline of the tubes to transmit and receiving ultrasonic signals, optimizing the detection of leaks by analyzing changes in signal amplitude.

A generator circuit excites the ultrasonic transducers using pulses, creating ultrasonic signals that pass through the assembly. A control circuit analyzes the received signals and detects any variations in amplitude, indicating the presence of water within the inner tube. The system operates at a frequency of in the range of 50 kilohertz to 500 kilohertz, with the generator circuit delivers pulses of with an amplitude magnitude in the range of 50 volts to 500 volts and a pulse width in the range of 50 nanoseconds to 10 microseconds. This system allows for the accurate detection of water ingress by analyzing resonance patterns and timing delays in the ultrasonic signals.

Specifically concerning the detection of leaks within nuclear fuel pool assemblies, the present disclosure describes an apparatus and method for detecting water ingress into sealed tubes containing cobalt slugs submerged in a nuclear fuel pool. Systems and methods according to the present disclosure employ ultrasonic technology and magnetic alignment to accurately detect leaks in submerged components. The present disclosure presents example systems, devices, and methods for detecting leaks inside sealed tubes filled with Cobalt slugs. It outlines a process for identifying a leaking Co-60 capsule without disassembling COBA rodlets from the baseplate of a nuclear core insert assembly. This approach helps prevent significant delays during utility outages if Co-60 levels rise above nominal during plant operation with COBA inserts in the core. A leak detection assembly provides that the utility (e.g., nuclear power plant operator) can install the test equipment, use existing support tooling compatible with the equipment, and confirm if a COBA assembly has a leaking capsule without disassembling the COBA rodlets from the insert plate. This process allows for equipment removal with minimal delays to the outage schedule.

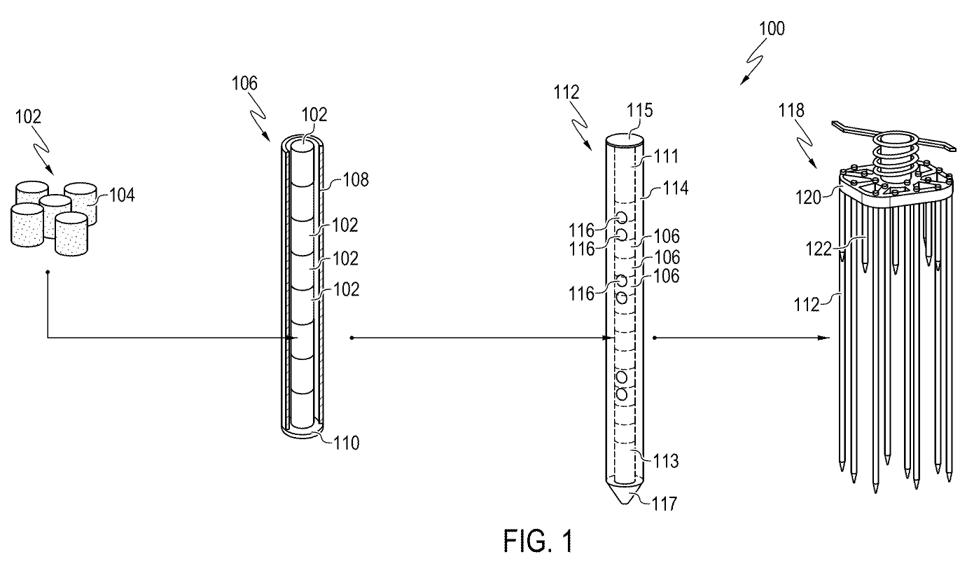

FIG. 1 depicts a Cobalt Burnable Absorber (COBA) assembly 100, according to one aspect of this disclosure. The COBA assembly 100 comprises multiple slugs 102 of Cobalt-59 target material, which may include a nickel plating 104. These slugs 102 are stacked within a target capsule 106, featuring a cladding 108, which can be low-cobalt stainless-steel, and a welded endcap 110, which can be stainless-steel. Multiple target capsules 106 are assembled to form a COBA rodlet 112, which includes a cladding 114 with defined perforations 116. The COBA rodlet 112 also has a top end plug 115 and a bottom end plug 117, which, in one aspect, is made of Zr-4 (zirconium-4). The COBA rodlet 112 also includes a top standoff tube 111 and a bottom standoff tube 113. The target capsules 106 are disposed between the top and bottom standoff tubes 111, 113. The top and bottom end plugs 115, 117 seal the COBA rodlet 112. A COBA insert assembly 118 is comprised of a stainless-steel down plate 120, several stainless-steel thimble plugs 122, and multiple COBA rodlets 112. The COBA insert assembly 118 are inserted into nuclear fuel assemblies and loaded into a nuclear reactor core as fuel assembly components to be irradiated for multiple fuel cycles, producing Cobalt-60. After removal of the COBA insert assemblies 118 from the nuclear reactor core, the activated target capsules 106 are removed from the COBA rodlets 112.

In one aspect, each target capsule 106 may contain eight (8) slugs 102, each measuring 1 inch in length and 0.25 inches in diameter, for example. In other aspects, the slugs 102 may be Nickel-plated Co-59 target material. Thirteen (13) target capsules 106 may be stacked to form a COBA rodlet 112. The COBA insert assembly 118 may include twelve (12) COBA rodlets 112 and 12 stainless-steel thimble plugs 122, for example. However, the scope of this disclosure is not limited to this configuration. The COBA insert assembly 118 may be adapted to suit various applications.

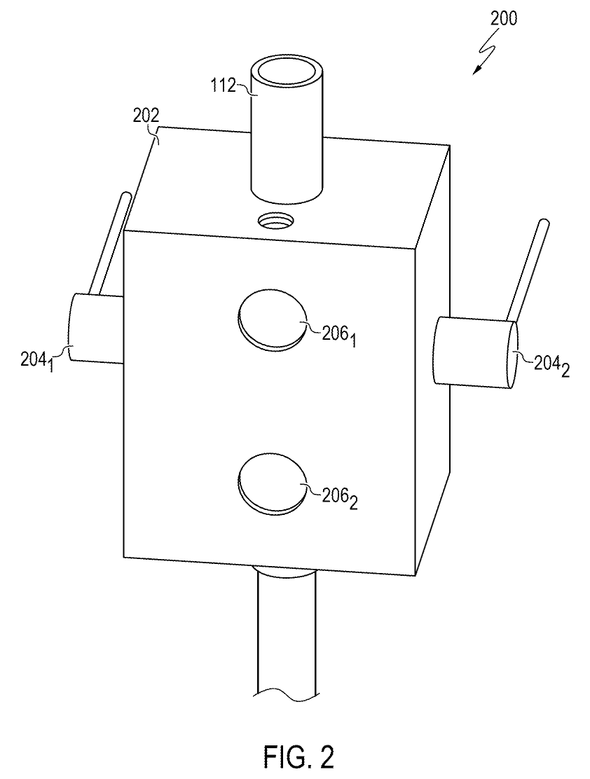

FIG. 2 illustrates a leak detection system 200 positioned over a COBA rodlet 112, according to one aspect of this disclosure. The leak detection system 200 comprises a transducer holder housing 202 equipped with one or more ultrasonic transducers 204₁, 204₂and one or more magnets 206₁, 206₂. The transducer holder housing 202 may be a stainless-steel block machine to hold the transducers 204₁, 204₂during the testing process. In one aspect, the COBA rodlet 112 may contain multiple Co-60 slugs 102 (FIG. 1). The functional aspects of the leak detection system 200 are detailed below.

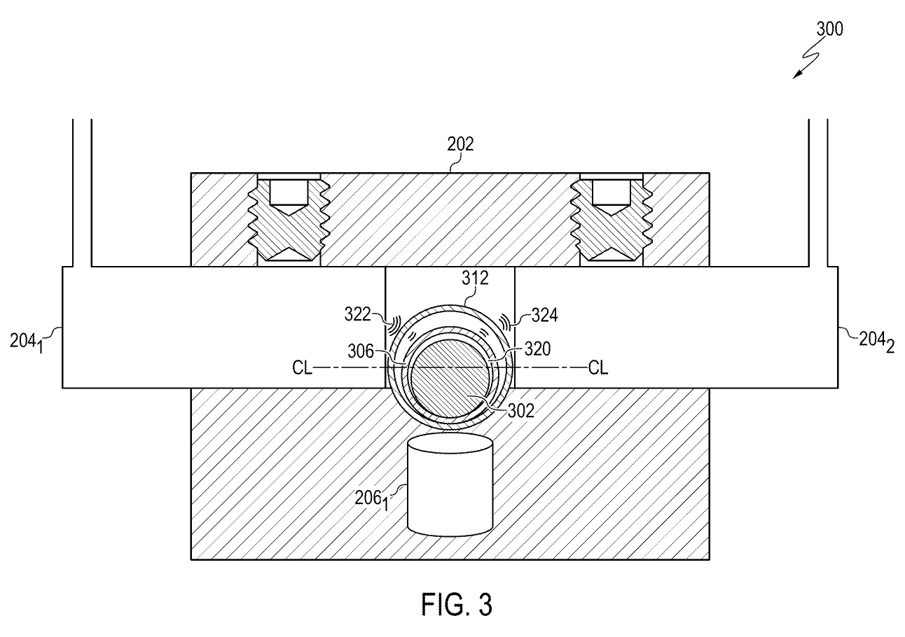

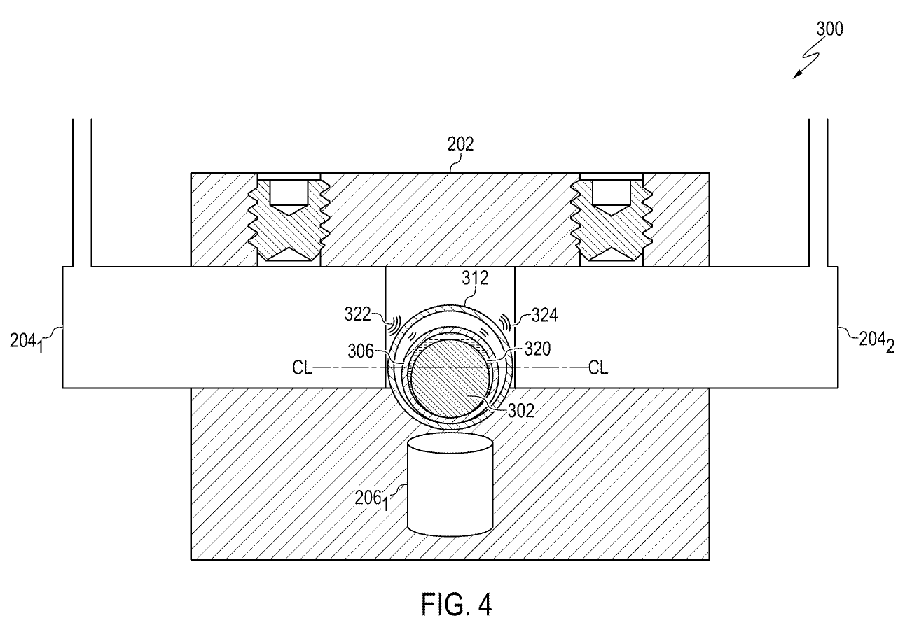

Turning to FIGS. 3 and 4, FIG. 3 shows a sectional view of a leak detection system 300 with a dry inner tube 306, while FIG. 4 illustrates the leak detection system 300 with a wet inner tube 306, indicating a leak. The inner tube 306 contains cobalt slugs 302. An outer tube 312, surrounding the inner tube 306, is filled with water and acts as a containment structure within the nuclear fuel pool. The leak detection system 300 is designed to maintain the integrity of the cobalt slugs 302 by detecting any water intrusion into the gap 320 between the cobalt slug 302 and the inner tube 306. In one configuration, the cobalt slug 302 corresponds to the slug 102, the inner tube 306 corresponds to the target capsule 106, and the outer tube 312 corresponds to the COBA rodlet 112, as shown in FIG. 1.

The transducer holder housing 202 contains a first ultrasonic transducer 204₁and a second ultrasonic transducer 204₂. As shown in FIG. 3, the first transducer 204₁functions as a transmitter, while the second transducer 204₂acts as a receiver. This transmitter/receiver setup can be swapped without affecting the operation of the leak detection system 300. To detect the presence of water or other liquids in a sealed inner tube 306 (such as a cobalt target capsule 106), the transducers 204₁, 204₂are positioned opposite each other and offset from the centerline CL of the outer tube 312 (such as a COBA rodlet 112). They operate in a pitch/catch configuration, transmitting and receiving ultrasonic signals 322, 324 at approximately 300 kHz. The offset positioning is optimized using principles from automated fuel inspection systems (APHIS).

In operation, an electrical excitation signal is used to excite the transmitter ultrasonic transducer 204₁and may be referred to as the excitation signal or driving signal. Generally, the electrical excitation signal is typically a high-frequency electrical pulse or continuous wave that drives the piezoelectric elements of the transmitter ultrasonic transducer 204₁. Once the transmitter ultrasonic transducer 204₁converts the electrical excitation into mechanical vibration, the resultant sound wave that propagates through the medium is called the transmitted ultrasonic signal or simply the ultrasound pulse. After the transmitted ultrasound wave interacts with objects or boundaries within the medium and reflects back, the returning wave is referred to as the reflected ultrasonic signal or received ultrasonic signal. Once the received ultrasonic signal is converted back into an electrical signal by the receiver ultrasonic transducer 204₂, it is called the received electrical signal or echo signal. This signal is typically processed by circuits and software for further analysis, for characterization of any leaks in the sealed inner tube 306.

The pitch-catch technique is an ultrasonic testing method where the transmitted ultrasonic signal 322 follows a complex path, reflecting one or more times before reaching the receiver transducer 204₂. This technique deviates from conventional methods and is particularly useful for distinguishing between wet and dry inner tubes 306 (such as cobalt target capsules 106). By employing a specific geometric configuration of two ultrasonic transducers 204₁, 204₂, the pitch-catch technique optimizes reflections from relevant interfaces while minimizing unwanted reflections.

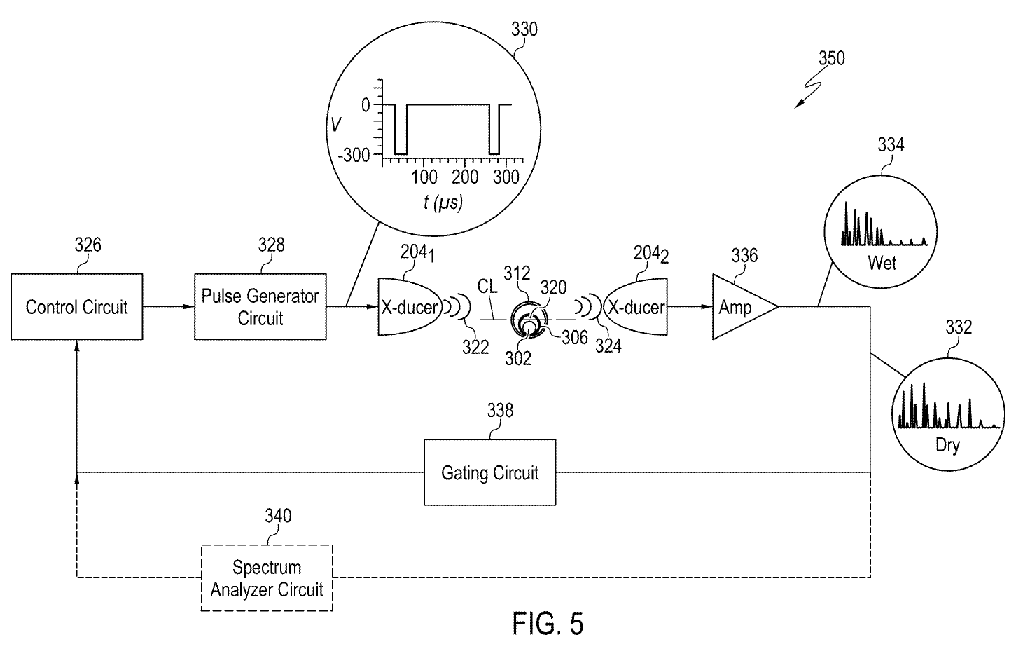

There are two main categories of pitch-catch techniques: direct and indirect. In direct pitch-catch, the receiver ultrasonic transducer 204₂is positioned where the reflected ultrasonic signal 324 is expected if the inner tube 306 (dry capsule) contains no water or other liquid. The presence of liquid is indicated if the reflected ultrasonic signal 324 is not detected as expected or if the signal strength is reduced. In contrast, the indirect pitch-catch technique places the receiver transducer 204₂where the reflected ultrasonic signal 324 is expected if liquid is present in the inner tube 306 (wet capsule). Both techniques can be used with the transmitter and receiver transducers 204₁, 204₂on the same side or opposite sides of the outer tube 312. When on the same side, a single ultrasonic transducer can be controlled by a control circuit 326 (FIG. 5) to switch from transmitting to receiving, using a single piezoelectric element to detect the reflected waves.

As shown in FIGS. 3 and 4, the leak detection system 200 includes permanent magnets 206₁, 206₂, which pull the inner tube 306 away from the centerline CL of the outer tube 312 due to the magnetic properties of the nickel-plated cobalt slugs 302. This creates a larger gap 320 between the inner and outer tubes. The offset ultrasonic transducer may be positioned on the side with the larger gap 320. If the inner tube 306 is leak-free, the gap 320 is filled with air, as depicted in FIG. 3. If a leak is present, the gap 320 fills with water or another liquid, as shown in FIG. 4. The magnets 206₁, 206₂, illustrated in FIG. 2, are arranged around the outer tube 312 to provide proper alignment of the cobalt slugs 302, providing a consistent structure for ultrasonic signal transmission and reception.

FIG. 5 illustrates a system 350 for detecting leaks in a nuclear fuel pool assembly, according to one aspect of this disclosure. A pulse generator circuit 328 produces electrical excitation signals 330 to excite the piezoelectric crystals of the transmitter ultrasonic transducer 204₁. The electrical excitation signals 330 may be in the form of pulses having an amplitude magnitude in the range of 50 volts to 500 volts and preferably 300 volts, a pulse width in the range of 50 nanoseconds to 10 microseconds and preferably 480 nanoseconds, and a repetition frequency of 10 hertz to 1,000 hertz and preferably 100 hertz. The receiver ultrasonic transducer 204₂captures the reflected ultrasonic signal 324 and converts it into an electrical signal 332, 334 using an amplifier circuit 336. A gating circuit 338 directs the received electrical signal 332, 334 to a control circuit 326, which processes it to detect water presence by analyzing changes in signal amplitude between the received electrical signal 332, 334 and the electrical excitation signal 330. The control circuit 326 also calculates the time delay between the electrical excitation signal 330 and the received electrical signal 332, 334 to measure signal propagation and amplitude, confirming any leakage. Alternatively, a spectrum analyzer circuit 340 may be coupled to the control circuit 326 to analyze the electrical power spectrum in the received electrical signal 332, 334 to determine if the inner tube 306 leaks.

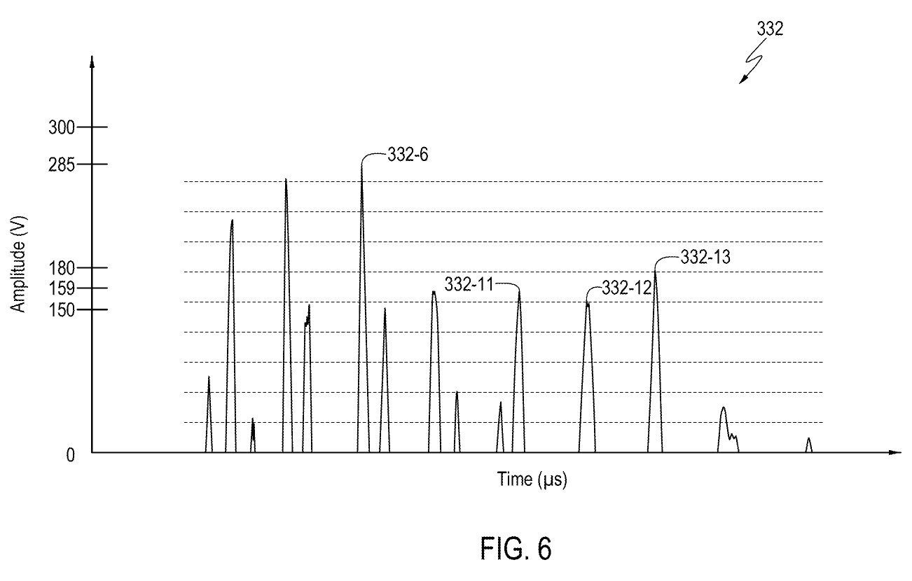

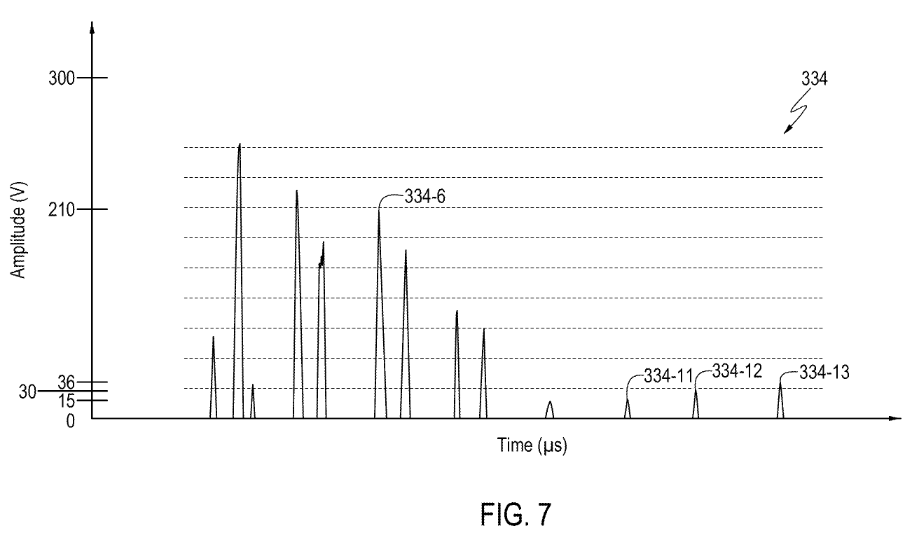

FIG. 6 shows a resonance pattern of a received electrical signal 332 for a dry inner tube 306, while FIG. 7 shows a resonant pattern of a received electrical signal 334 for a wet inner tube 306. The vertical axis is the amplitude in volts of the received electrical signal 332, 334 received by the receiver ultrasonic transducer 204₂. The horizontal axis is time in microseconds (μs). The transmitter ultrasonic transducer 204₁is excited by 300 V electrical excitation signals 330 and the magnets 206₁, 206₂were positioned 90 degrees apart. The sample rate was set to 50 megahertz. Referring first to FIGS. 5 and 6, FIG. 6 shows a resonant pattern of the received electrical signal 332 typical of a dry, non-leaking, inner tube 306 (such as the target capsule 106). The resonant pattern is interpreted by the control circuit 326 (or a spectrum analyzer circuit) by gating the individual peaks of the received electrical signal 332 and analyzing the amplitude of each peak, and/or a time delay relative to the electrical excitation signal 330. The received electrical signal 332 peaks are analyzed in terms of percentage of full scale (FS) V. As shown, the 6th peak 332-6 of the dry received electrical signal 332 is 95% FS, the 11th peak 332-11 is 53% FS, the 12th peak is 50% FS, and the 13th peak is 60% FS. The readings stay consistent with axial probe movement.

Referring now to FIG. 7, together with FIGS. 5 and 6, the resonance pattern of the received signal 334 indicates that at least four signal peaks were attenuated due to the presence of water in the inner tube 306. As shown, several peaks of the leaking—wet inner tube 306, are significantly attenuated when compared to the non-leaking inner tube 306 shown in FIG. 6. As shown in FIG. 7, the 6th peak 334-6 of the wet received electrical signal 334 is attenuated to 70% FS, which is down from 95% FS compared to the 6th peak 332-6 for a dry inner tube 306. The 11^{th} peak 334-11 is attenuated to 5% FS, down from 53% FS for a dry inner tube 306. The 12^{th} peak 334-12 is attenuated to 10% FS, down from 50% FS compared to the 12^{th} peak 332-12 for a dry inner tube 306. Finally, the 13^{th} peak 334-13 is attenuated to 12% FS, down from 60% FS of a dry inner tube 306. A software application can record results as the outer tube 312 (such as a COBA rodlet 112) moves through the leak detection system 300. For enhanced analysis, the control circuit 326 may include a spectrum analyzer circuit to evaluate the power distribution of ultrasonic signals across frequencies, optimizing detection and ensuring precise identification of water ingress. The readings stay consistent with axial probe movement.

The leak detection system 200, 300, as shown in FIGS. 1-7, operates by transmitting ultrasonic signals 322 through the system, including the inner tube 306 and the outer tube 312 submerged in the nuclear fuel pool. The transmitted ultrasonic signals 322 travel through the material and are received by the transducer 204₂positioned around the assembly. The control circuit 326 monitors the amplitude of the received electrical signals 332, 334. If water is present inside the inner tube 306, indicating a leak, the amplitude changes, which the control circuit 326 detects.

The cobalt slugs 302, aligned by magnets 206₁, 206₂, form a consistent structure that enables accurate signal comparison. The system analyzes these signals against predefined thresholds to determine if the inner tube 306 is dry or wet. By "gating" individual peaks—each representing a specific time frame in the transmitted signal the system employs a go/no-go method to detect the presence of water inside the inner tube 306.

The pulse transmission system uses an electrical excitation signal 330 with an amplitude magnitude in the range 50 volts to 500 volts and preferably an amplitude magnitude of 300 volts lasting in the range of 50 nanoseconds to 10 microseconds and preferably 480 nanoseconds to excite at least one of the ultrasonic transducers 204₁, 204₂. With a pulse repetition frequency in the range 10 hertz to 1,000 hertz and preferably 100 hertz, approximately 2,000 samples are collected at a sample rate in the range of 10 megahertz to 100 megahertz and preferably a sample rate of 50 megahertz. The pulse observation window is set to in the range of 1 microsecond to 10 microseconds and preferably about 4 microseconds, adjustable based on system configurations. The control circuit 326 calculates the time delay in receiving the electrical signals 332, 334 to determine the signal propagation in the outer tube 312. This time delay helps confirm the presence of water within the inner tube 306, enhancing the accuracy of the leak detection system 200, 300.

The leak detection system 200, 300 is scalable, enabling testing of individual rods or target capsules 106 within the COBA assembly 100. The leak detection system 200, 300 can test assemblies with 12 COBA rodlets 112, each containing 13 target capsules 106 filled with 8 cobalt slugs 102. The system may also use a stainless-steel block machine to hold the transducers 204₁, 204₂, ensuring consistent positioning for leak detection from various points within the assembly. The leak detection system 200, 300 can test assemblies with a determined number of COBA rodlets 112, each containing multiple target capsules 106 filled with a plurality of cobalt slugs 102. Accordingly, the claimed subject matter should not be limited in this context.

The leak detection system 200, 300 is designed for use in nuclear facilities to monitor and detect leaks in submerged nuclear fuel pool assemblies. Its ability to accurately detect water ingress using ultrasonic transducers and magnetic alignment provides a robust and reliable solution for ensuring the safety and integrity of critical components. The system's scalable design allows adaptation to various assembly sizes and configurations, making it suitable for diverse applications within the nuclear energy industry. By utilizing advanced ultrasonic technology and magnetic alignment, the system offers a novel and effective method for leak detection. Its capability to analyze signal amplitude and resonance patterns enables precise identification of water ingress, making it a valuable tool for maintaining the safety and operational efficiency of nuclear fuel pools. The system's scalability and adaptability further enhance its potential for widespread use across nuclear facilities.

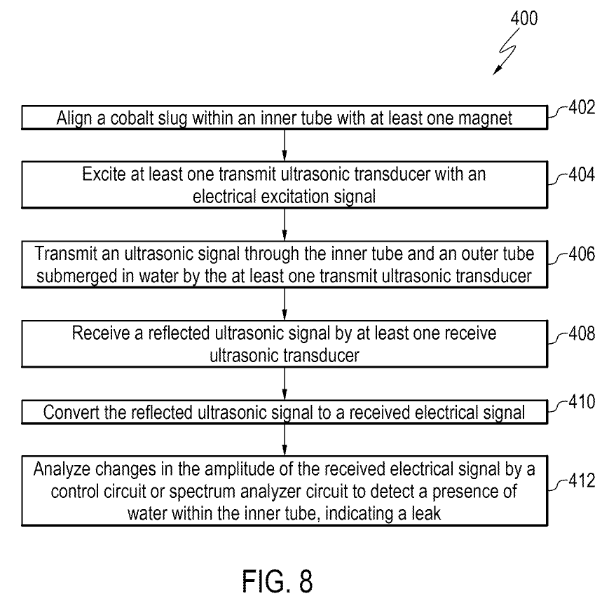

FIG. 8 is a method 400 for detecting leaks in a nuclear fuel pool assembly, according to one aspect of the present disclosure. With reference now to FIG. 8 in conjunction with FIGS. 1-7, in one embodiment, cobalt slugs 102, 302 are aligned 402 within an inner tube 306 (such as the target capsule 106) by one or more magnets 206₁, 206₂. Ultrasonic signals 322 are transmitted 404 through the inner tube 306 and an outer tube 312 (such as the COBA rodlet 112) submerged in water by at least one ultrasonic transducer 204₁. The transmitted ultrasonic signals 322 are received 406 by at least one ultrasonic transducer 204₂. At least one ultrasonic transducer 204₂converts 408 the received ultrasonic signals 324 into received electrical signals 332, 334. Changes in the amplitude of the received electrical signals 332, 334 are analyzed 412 to detect a presence of water within the inner tube 306, indicating a leak.

In one aspect, the ultrasonic transducers 204₁, 204₂are positioned offset from a centerline CL of the inner tube 306 and the outer tube 312 to optimize leak detection.

In one aspect, the ultrasonic signals 322 are transmitted by exciting piezoelectric crystals in at least one ultrasonic transducer 204₁using an electrical pulse with an amplitude magnitude in the range of 50 volts to 500 volts and a pulse width in the range of 50 nanoseconds to 10 microseconds.

In one aspect, individual peaks in the received electrical signal are gated and analyzed to determine whether the inner tube 306 is dry or wet.

In one aspect, a time delay between the electrical excitation signal and the received electrical signal is calculated to determine a velocity of water within the outer tube and using this information to confirm the presence of a leak in the inner tube.

In one aspect, individual cobalt slugs 102, 302 or COBA rodlets 112/outer tubes 312 within the insert assembly 118 are tested by selectively analyzing the received electrical signal 332, 334 corresponding to each cobalt slug 102, 302 or COBA rodlet 112/outer tube 312 to determine whether a specific cobalt slug 102, 302 or COBA rodlet 112/outer tube 312 is associated with a leak.

In one aspect, the frequency of the transmitted ultrasonic signals 322 is adjusted in a range of approximately 50-500 kilohertz to enhance detection accuracy.

In one aspect, electrical power distribution is analyzed over a range of frequencies using a spectrum analyzer circuit to improve detection accuracy of the leak and the analyzed data is compared with predefined thresholds to determine whether water ingress has occurred.

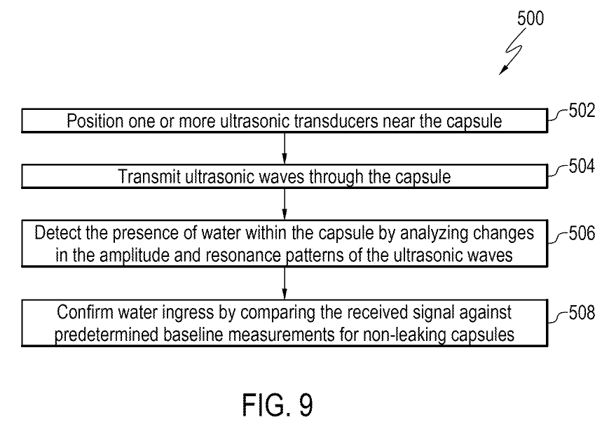

FIG. 9 is a method 500 for detecting water ingress in a sealed cobalt-containing capsule submerged in a nuclear fuel pool, according to one aspect of the present disclosure. With reference now to FIG. 9 in conjunction with FIGS. 1-7, in one embodiment, one or more ultrasonic transducers 204₁, 204₂are positioned 502 near a target capsule 106/inner tube 306. The ultrasonic signals 322 are transmitted 504 through the target capsule 106/inner tube 306. The presence of water within the target capsule 106/inner tube 306 is detected 506 by analyzing changes in the amplitude and resonance patterns of the reflected ultrasonic signals 324. Water ingress is confirmed 508 by comparing the received electrical signal 334 against predetermined baseline measurements for non-leaking capsules.

In one aspect, the position of cobalt slugs 102, 302 is adjusted within the target capsule 106/inner tube 306 with magnets 206₁, 206₂to provide uniform ultrasonic transmission and reception.

In one aspect, the analysis involves detecting consistent resonance patterns and changes in ultrasonic signal amplitude to determine the presence of water within the target capsule 106/inner tube 306.

In one aspect, the offset positioning of the ultrasonic transducers 204₁, 204₂is adjusted relative to the centerline CL of the target capsule 106/inner tube 306 to optimize detection sensitivity.

In one aspect, the system is calibrated by transmitting test signals through non-leaking target capsules 106/inner tubes 306 to establish baseline resonance and amplitude patterns for comparison.

The foregoing description presents various embodiments of systems and processes through block diagrams, flowcharts, and examples. Each of the depicted components, functions, or operations may be implemented using hardware, software, firmware, or combinations thereof. Specific features can be executed using integrated circuits, computer programs, or processors (e.g., microprocessors, microcontrollers), as well as other software-hardware combinations. The design and development of such implementations, whether via circuitry or software, are within the technical expertise of those skilled in the art. Moreover, the described methods and mechanisms may be distributed as program products on various media, with no restriction on the format of the medium.

Instructions for implementing these features can be stored in various types of memory, including dynamic random-access memory (DRAM), flash memory, and/or cache. These instructions can also be distributed over a network or via other computer-readable media. The term "non-transitory computer-readable medium" refers to any physical medium capable of storing or transmitting instructions or information that can be read by a machine. Examples include, but are not limited to, optical disks, CD-ROMs, RAM, ROM, EPROM, EEPROM, magnetic or optical cards, flash memory, or even propagated signals such as carrier waves or infrared signals.

Software components described herein may be implemented using languages such as Visual Studio.NET, Python, Java, C++, or Perl. The corresponding software code may be stored on various computer-readable media, such as RAM, ROM, hard drives, or CD-ROMs. These media may be part of a single computational device or distributed across multiple devices within a networked system.

The term "control circuit" encompasses hardwired circuitry, programmable logic (such as microprocessors, microcontrollers, digital signal processors (DSPs), programmable logic devices (PLDs), programmable gate arrays (PGAs), or field-programmable gate arrays (FPGAs)), state machines, or firmware that executes stored instructions. Control circuits may form part of larger systems, such as integrated circuits (ICs), application-specific integrated circuits (ASICs), or systems -on -chips (SoCs), and are commonly found in devices such as computers, smartphones, and servers. These circuits may perform tasks involving data processing, communication, or data storage.

In some embodiments, the control circuit can utilize machine learning (ML) techniques to make decisions based on sensor inputs or other data. ML methods may include supervised learning (with labeled inputs and outputs), unsupervised learning (for identifying patterns), or reinforcement learning (where the system adapts based on feedback). tasks for ML systems may involve classification, regression, clustering, anomaly detection, or optimization, with algorithms such as decision trees, deep learning, support vector machines (SVMs), or neural networks being employed, depending on the application.

A control circuit may also incorporate a policy engine that applies specific rules based on equipment characteristics or environmental conditions. For instance, a neural network could process sensor data or operational inputs to determine appropriate actions. techniques such as backpropagation or evolutionary strategies may be used to refine neural network parameters and optimize model selection for the given task.

The system may handle data generation, transmission, and storage, potentially leveraging both protected and exposed data sources. Encryption and decryption can be applied during data transit, at rest, or in use, with keys and schemas determined based on operational needs. The control circuit may monitor and enforce decision boundaries, ensuring that data from protected sources meets safety or operational thresholds. If data breaches these boundaries, the system may initiate actions such as equipment shutdown, component isolation, or transitioning to safe mode to mitigate potential risks or damages.

The term "logic" refers to software, firmware, and/or circuitry configured to execute the described operations. Logic may be implemented as applications, software packages, instruction sets, or data stored on non-transitory computer-readable storage media. Firmware may be hard-coded into memory devices. Components and modules described herein may be hardware, software, or a combination thereof, and may be in active, inactive, or standby states depending on system requirements.

An "algorithm" refers to a sequence of steps designed to achieve a specific result. These steps may manipulate physical quantities, typically in the form of electrical or magnetic signals, which are represented as bits, values, symbols, or numbers. The terms used to describe these processes are labels for the underlying physical operations.

The system may operate over a packet-switched network using various communication protocols, including Ethernet (complying with IEEE 802.3 standards), X.25, frame relay, or Asynchronous Transfer Mode (ATM). Communication between devices may follow established protocols such as TCP/IP or new emerging standards.

Terms such as "processing," "computing," "calculating," or "determining" refer to operations carried out by computing systems or electronic devices, which manipulate data represented as physical (electronic) quantities within memory or registers.

Terms like "component," “system," and "module" refer to computer-related entities, whether hardware, software, or a combination thereof. One or more components may be described as "configured to," "configurable to," "operable/operative to," "adapted/adaptable to," or similar terms. Unless explicitly stated, these terms encompass components in both active and inactive states.

Unless stated otherwise, terms like "including" or "having" should be interpreted as open-ended (i.e., "including but not limited to"). Numeric claim recitations generally mean "at least" the stated number, and disjunctive terms like "A or B" should be interpreted to include either or both unless explicitly specified. Operations in any claim may generally be performed in any order unless explicitly stated. The recitation "at least one of A, B, and C" should be interpreted as any combination of A, B, and C, such A alone, B alone, C alone, A and B together, A and C together, B and C together, and/or A, B, and C together. The recitation "at least one of A, B, or C" should be interpreted to include A alone, B alone, C alone, A and B together, A and C together, B and C together, and/or A, B, and C together.

In summary, various embodiments have been described to illustrate the principles and applications of the disclosed systems and methods. These descriptions are not intended to limit the scope of the claimed subject matter, and variations may be made by those skilled in the art. The accompanying claims define the broadest legal scope of this disclosure.

What is claimed is:

1. A system for detecting leaks in a nuclear fuel pool assembly, the system comprising:
an inner tube containing a plurality of cobalt slugs;
an outer tube surrounding the inner tube, wherein both the inner tube and the outer tube are submerged in water;
one or more magnets configured to align the cobalt slugs within the inner tube;
one or more ultrasonic transducers positioned in proximity to the inner tube and the outer tube, offset from a centerline of the outer tube, for transmitting and receiving ultrasonic signals;
a generator circuit configured to excite at least one of the one or more ultrasonic transducers using an electrical excitation signal; and
a control circuit configured to analyze changes in signal amplitude to detect a presence of water in the inner tube.

2. The system of claim 1, wherein the one or more ultrasonic transducers operate at a frequency in a range of 50 kilohertz to 500 kilohertz and are positioned to optimize leak detection.

3. The system of claim 1, wherein the generator circuit is configured to excite at least one of the one or more ultrasonic transducers using a pulse with an amplitude magnitude in a range of 50 volts to 500 volts with a pulse width in a range of 50 nanoseconds to 10 microseconds and a repetition frequency in a range of 10 hertz to 1,000 hertz.

4. The system of claim 1, comprising a gating circuit configured to analyze individual signal peaks and determine whether the inner tube is dry or wet.

5. The system of claim 1, wherein the control circuit is configured to analyze resonance patterns of received electrical signals to detect changes caused by water in the inner tube.

6. The system of claim 1, wherein the control circuit is configured to measure a time delay between a received electrical signal and the electrical excitation signal to calculate signal propagation and amplitude.

7. The system of claim 1, comprising a spectrum analyzer circuit to analyze power distribution over a frequency range to improve detection accuracy.

8. A method for detecting leaks in a nuclear fuel pool assembly, the method comprising:
aligning a cobalt slug within an inner tube using at least one magnet;
exciting at least one transmitting ultrasonic transducer with an electrical excitation signal;
transmitting an ultrasonic signal through the inner tube and an outer tube submerged in water by the at least one transmitting ultrasonic transducer;
receiving a reflected ultrasonic signal by at least one receiving ultrasonic transducer;
converting the reflected ultrasonic signal to a received electrical signal; and
analyzing changes in an amplitude of the received electrical signal by a control circuit or spectrum analyzer circuit to detect a presence of water within the inner tube, indicating a leak.

9. The method of claim 8, comprising positioning the at least one transmit or receiving ultrasonic transducer offset from a centerline of the inner tube and the outer tube to optimize leak detection.

10. The method of claim 8, comprising transmitting the ultrasonic signal by exciting a piezoelectric crystal in the at least one transmitting ultrasonic transducer using an electrical pulse with an amplitude magnitude in a range of 50 volts to 500 volts and an electrical pulse width in a range of 50 nanoseconds to 10 microseconds.

11. The method of claim 8, comprising:
gating individual peaks in the received electrical signal; and
analyzing the individual peaks in the received electrical signal to determine whether the inner tube is dry or wet.

12. The method of claim 8, comprising calculating a time delay between the electrical excitation signal and the received electrical signal to determine a velocity of water within the outer tube and using this information to confirm the presence of a leak in the inner tube.

13. The method of claim 8, comprising:
testing individual cobalt slugs or rodlets within the assembly by selectively analyzing the received electrical signal corresponding to each slug or rodlet; and
determining whether a specific slug or rodlet is associated with a leak.

14. The method of claim 8, comprising adjusting a frequency of the transmitted ultrasonic signal in a range of 50 kilohertz to 500 kilohertz to enhance detection accuracy.

15. The method of claim 8, comprising:
analyzing electrical power distribution over a range of frequencies using the spectrum analyzer circuit to improve detection accuracy of the leak; and
comparing analyzed electrical power distribution data with predefined thresholds to determine whether water ingress has occurred.

16. A method for detecting water ingress in a sealed cobalt-containing capsule submerged in a nuclear fuel pool, the method comprising:
positioning at least one ultrasonic transducer near the capsule;
transmitting an ultrasonic signal through the capsule;
detecting presence of water within the capsule by analyzing changes in amplitude and resonance patterns between a transmitted ultrasonic signal and a reflected ultrasonic signal; and
confirming water ingress by comparing the reflected ultrasonic signal to predetermined baseline measurements for non-leaking capsules.

17. The method of claim 16, comprising adjusting a position of at least one cobalt slug located within the capsule using magnets to provide uniform ultrasonic transmission and reception.

18. The method of claim 16, comprising detecting consistent resonance patterns and changes in ultrasonic signal amplitude to determine the presence of water within the capsule.

19. The method of claim 16, comprising adjusting offset positioning of the at least one ultrasonic transducer relative to a centerline of the capsule to optimize detection sensitivity.

20. The method of claim 16, comprising calibrating the sealed cobalt-containing capsule by transmitting test ultrasonic signals through non-leaking capsules to establish baseline resonance and amplitude patterns for comparison.
